(19) United States
(12) Patent Application Publication
(10) Pub. No.: US 2007/0169036 A1
(43) Pub. Date: Jul. 19, 2007

(54) Incremental type inferencing engine

(75) Inventors: Richard L. Garner, Issaquah, WA (US); Jeffrey A. Scofield, Seattle, WA (US); Balasubramanian Viswanathan, Kirkland, WA (US)

Correspondence Address: LEYDIG, VOIT & MAYER, LTD.;(SEATTLE OFFICE), TWO PRUDENTIAL PLAZA, SUITE 4900, CHICAGO, IL, 60601-6731, US

(73) Assignee: DHI Technologies, Inc., Renton, WA (US)

(21) Appl. No.: 11/263,110

(22) Filed: Oct. 31, 2005

(51) Int. Cl. G06F 9/45

(52) U.S. Cl. 717/143; 717/136; 717/140

(57) ABSTRACT

Computer program source code may be parsed to generate corresponding type constraints. The type constraints may be incrementally resolved to achieve incremental type inferencing of various programmatic elements specified by the source code. In contrast to conventional type inference, incremental type inferencing may enable the inference of type information for programmatic elements specified by a programming language that was not designed for type inference. One or more type constraints may be incrementally added to a constraint set and the constraint set repeatedly unified. Unification anomalies may arise during this process. For example, type mismatches corresponding to potential flaws in the source code may be detected by the unification process. In response to some or all of these anomalies, one or more entries may be made in a type anomaly audit. A separate such audit may be provided with respect to each intended deployment platform.

### FIELD OF THE INVENTION

This invention pertains generally to computing and, more particularly, to computer programming.

### BACKGROUND OF THE INVENTION

The computers that have become common in our workplaces and homes are running programs of ever greater sophistication and complexity to carry out their designated tasks. In particular, the advent of heterogeneous networks of cooperating and interacting computers has placed increasing demands on computer programs and computer programmers. In response, there has been an explosion of computer programming languages and associated technologies, each with their own features and advantages. However, this proliferation has itself become a source of problems.

Computing standards, in particular programming and interoperability standards, seek to establish some core functionality, some programmatic platform, upon which reliable computer programs may be built. One intent of such standards is to moderate technology proliferation problems. However, in practice, individual technology vendors are often motivated to implement functionality different from and/or outside of standards, for example, to competitively distinguish their product offerings and/or to solve problems not addressed by the standards. Standards alone rarely provide all that is necessary to build reliable computer programs.

Automated standards compliance analysis and enforcement tools can help, but conventional tools are relatively unsophisticated, incomplete and/or are hampered by a trend away from strict programming languages. Programming languages and environments that permit looser programming styles can sometimes raise programmer productivity in the short term. However, in the long term, for larger computer programming projects and/or for larger programming teams, languages and technologies permitting lax programming practice can compromise computer program integrity. For example, lax programming practice may undermine a computer program's reliability, particularly in a dynamic heterogeneous computing environment. Even small instabilities can become serious over time, for example by diminishing the computer program's flexibility with respect to modifications in response to changing requirements.

A particularly troubling class of programming environments that permit looser programming styles are those in which the programming language is designed to be interpreted (e.g., as opposed to compiled) and/or in which one or more significant standards compliance checks are deferred until runtime. Illustrative examples include Tool Command Language (Tcl), Practical Extraction and Report Language (Perl), Python, Ruby and scripting languages corresponding to the European Computer Manufacturers Association ECMA-262 (ECMAScript) series of programming standards such as JScript and JavaScript. Ensuring reliability and even correct functioning for such programming environments can require a prohibitively expensive testing regime, for example, in terms of time and/or resources. Typically, testing falls well short of comprehensive, with detrimental consequences for users of the resulting computer program.

The situation can be improved if the objects and/or variables of the programming environment are well-typed or strongly-typed. Computer programs involve manipulation of variables in accordance with sets of operations. Each type of variable may be associated with a particular set of valid operations. Sources of indeterminacy and/or error may be identified prior to runtime by checking that each variable of a particular type is in fact manipulated only by operations that are valid for that variable type. For example, an operation that returns a specified element of an array may cause an error if it is applied to a variable that is not an array type variable. Unfortunately, programming environments that permit looser programming styles tend to also permit poorly-typed or weakly-typed variables and/or objects.

Commonly, in conventional programming environments, achieving a well-typed computer program involves explicit declaration of variable types. Just as commonly, such explicit declaration is perceived as burdensome by computer programmers and omitted up to the extent allowed by the programming environment. Some conventional programming environments, such as programming environments incorporating one the ML family of functional programming languages, can achieve well-typing without requiring explicit declaration of variables types, for example, by utilizing a mechanism known in the art as Hindley-Milner type inference. However, such programming languages are designed and/or incorporate significant design features to enable conventional type inference and, because of consequent programming style strictures, are typically perceived as academic programming languages unsuited for commercial projects.

### BRIEF SUMMARY OF THE INVENTION

This section presents a simplified summary of some embodiments of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

In an embodiment of the invention, computer program source code is parsed to generate corresponding type constraints. The type constraints may be incrementally resolved to achieve incremental type inferencing of various programmatic elements specified by the source code. In contrast to conventional type inference, incremental type inferencing may enable the inference of type information for programmatic elements specified by a programming language that was not designed for type inference. In an embodiment of the invention, one or more type constraints are incrementally added to a constraint set and the constraint set is repeatedly unified. Unification anomalies may arise during this process. For example, type mismatches corresponding to potential flaws in the source code may be detected by the unification process. In response to some or all of these anomalies, one or more entries may be made in a type anomaly audit.

### BRIEF DESCRIPTION OF THE SEVERAL VIEWS OF THE DRAWING(S)

While the appended claims set forth the features of the invention with particularity, the invention and its advantages are best understood from the following detailed description taken in conjunction with the accompanying several views of the drawing(s), of which:

FIG. 1 is a schematic diagram illustrating an example computing environment suitable for incorporating and/or implementing an embodiment of the invention;

FIG. 2 is a schematic diagram illustrating an example networked computing environment suitable for incorporating an embodiment of the invention;

FIG. 3 is a schematic diagram depicting an example high level architecture for a computer program development system in accordance with an embodiment of the invention;

FIG. 4 is a block diagram depicting an example incremental constraint resolver in accordance with an embodiment of the invention;

FIG. 5 is a flowchart depicting example steps for incremental type inferencing in accordance with an embodiment of the invention;

FIG. 6 is a flowchart depicting example steps for incremental constraint resolution in accordance with an embodiment of the invention;

FIG. 7 is a flowchart depicting example steps for verificand constraint set resolution in accordance with an embodiment of the invention;

FIG. 8 is a matrix diagram illustrating an example type coercion matrix element for determining coercion allowability in accordance with an embodiment of the invention;

FIG. 9 is a matrix diagram illustrating an example type coercion matrix element for user-configurable coercion reporting in accordance with an embodiment of the invention; and

FIG. 10 is a flowchart depicting example steps for activating a call site contingent constraint in accordance with an embodiment of the invention.

### DETAILED DESCRIPTION OF THE INVENTION

In an embodiment of the invention, difficulties of effective type inference for arbitrary, and in particular commercial, computer programming languages and environments are overcome. As a result, computer program developers may enjoy benefits of a well-typed computer program without a burdensome requirement of explicit type declaration. In particular, such developers may be advised of computer program incongruities, anomalies and/or applicable standards violations prior to execution of the computer program. A separate computer program audit may be provided with respect to each programmatic platform or each class of programmatic platform to which it is intended that the computer program be deployed. An incremental type inferencing engine in accordance with an embodiment of the invention may utilize contingent constraints to manage indeterminacies arising in computer programming languages and environments not explicitly designed for type inference.

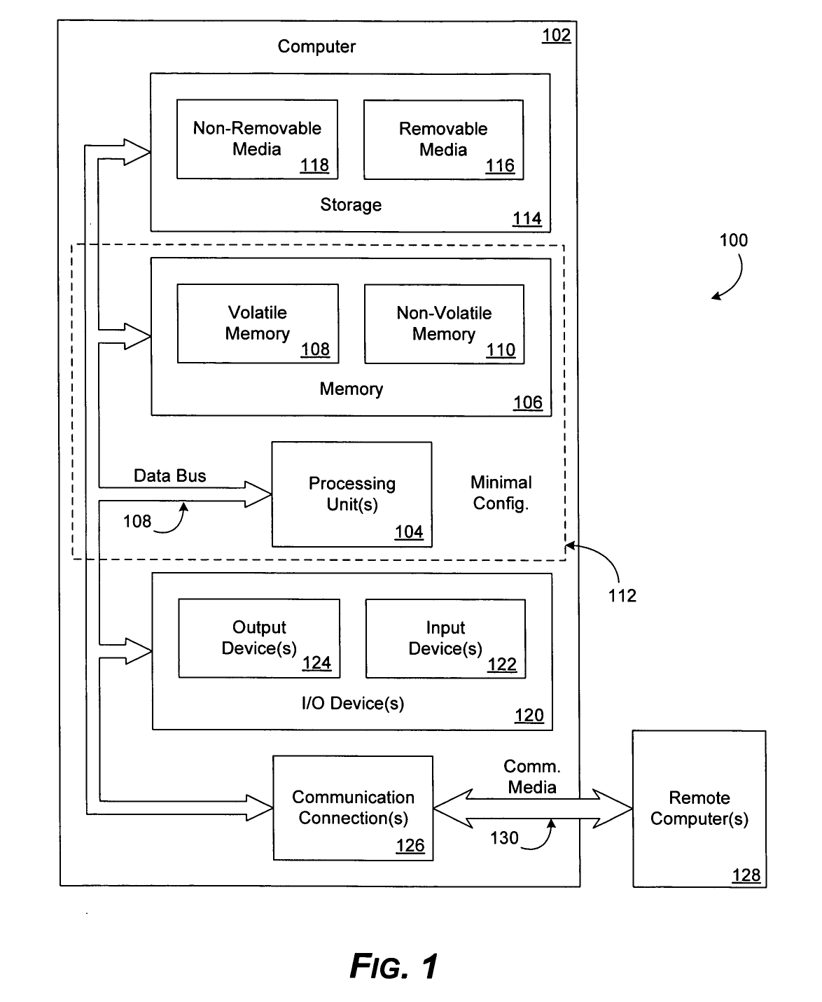

Before describing embodiments of the invention in more detail, it will be helpful to provide context and details with respect to computing environments suitable for incorporating and/or implementing embodiments of the invention. FIG. 1 illustrates an example of a suitable computing environment 100. The computing environment 100 may include a computer 102 having one or more processing units 104 and memory 106 connected by a data bus 108.

Each processing unit 104 may execute instructions to perform tasks in accordance with an embodiment of the invention. Each processing unit 104 may send and/or receive signals, for example, over the data bus 108. Each processing unit 104 may transform and/or generate signals, for example, in the course of executing instructions. In an embodiment of the invention, such signals are electronic signals representing digital data. However, each embodiment of the invention is not so limited. For example, data may be analog in nature, and signals may be encoded and/or transformed with any suitable physical phenomena including those associated with mechanics and optics.

The memory 106 may maintain data in addressable locations and provide the data to other components of the computer 102, for example, over the data bus 108. The memory 106 may include volatile memory 108 such as suitable random access memory (RAM), dynamic RAM (DRAM) and synchronous DRAM (SDRAM), and/or non-volatile memory 110 such as suitable read-only memory (ROM), erasable programmable ROM (EPROM), electrically-erasable programmable ROM (EEPROM) and flash memory. Processing unit(s) 104 may physically incorporate memory such as memory 106 (e.g., include cache memory).

The memory 106 may store one or more computer programs and/or computer program components. Each computer program and/or program component may include instructions executable by the processing unit(s) 104 and/or structured or unstructured data. Each computer program and/or program component may include modules, routines and/or any suitable programmatic object to organize the instructions and/or data. Each computer program and/or program component may include and/or correspond to elements of one or more computer programming languages. Any suitable computer programming language may be utilized to create computer programs and/or program components including, without limitation, machine and assembly languages, procedural programming languages, imperative programming languages, functional programming languages, object-oriented programming languages, interpreted programming languages, complied programming languages and combinations thereof.

The dashed line 112 delineates a minimal configuration of the computer 102. The computer 102 may further include storage 114 connected to the memory 106 and/or processing unit(s) 104 by the data bus 108. The storage 114 may include removable 116 and non-removable 118 media. The storage 114 may include any suitable computer-readable media including, without limitation, magnetic media such as hard disks, floppy disks and tapes, optical media such as compact disks (CD) and digital versatile disks (DVD), volatile and non-volatile media such as RAM, ROM and flash memory, and combinations thereof. The storage 114 may store any suitable data. Transfer of data to and from the storage 114, for example, to the memory 106, may require processing by the processing unit(s) 104.

The computer 102 may further include one or more input/output (I/O) devices 120 capable of capturing and providing data to and from the computer 102. The I/O devices 120 may include any suitable input device(s) 122 such as keyboards, keypads, mice, touchpads, trackballs, pens, joysticks, gamepads, scanners, webcams, microphones, and associated device interface hardware. The I/O devices 120 may include any suitable output device(s) 124 such as monitors, liquid crystal displays (LCD), light emitting diodes (LED), printers, speakers, and associated device interface hardware. Transfer of data to and from the I/O devices 120, for example, from and to the memory 106, may require processing by the processing unit(s) 104.

The computer 102 may further include one or more communication connections 126 providing, or capable of providing, communication with one or more remote computers 128 in the computing environment 100 over suitable communication media 130. For example, the communication connection(s) 126 may be maintained with I/O devices 120 such as modems or network interface hardware. Communication media 130 may include any suitable wired communication media such as copper wire, coaxial cable and optical fiber, as well as any suitable wireless communication media such as electro-magnetic media including radio, microwave, infra-red and laser. Data, for example, from the memory 106, may be encoded and transmitted over the communication media with any suitable communication technology and/or protocol. The storage 114, the communication connection(s) 126 and the communication media 180 are each examples of computer-readable media.

When the computer 102 and remote computer(s) 128 are linked by communication connection(s) 126, programs and/or program components may be distributed among the memory 106 and/or storage 114 of both the local 102 and remote 128 computers. Furthermore, in such a distributed computing environment, program and/or program component instructions may be executed by the processing unit(s) 104 of both the local 102 and remote 128 computers. Each computer 102, 128 may be, or be incorporated by, any suitable type of computer or computing device including, without limitation, a personal computer (PC), a desktop computer, a laptop computer, a tablet computer, a personal digital assistant (PDA), a workstation, a minicomputer, a server, a mainframe, a router, a gateway, a switch, a hub, a mobile phone and a programmable consumer electronics device or other embedded computer.

For clarity, embodiments of the invention may be described with reference to symbolic operations and manipulations of structured data in a suitable computer programming language. As described above, such operations, manipulations and structures correspond to physical states of components and changes in components of computers such as the computers 102, 128 in a manner well understood by one of skill in the art. Furthermore, in an embodiment of the invention, each such operation, manipulation and/or structure may be fully implemented in hardware.

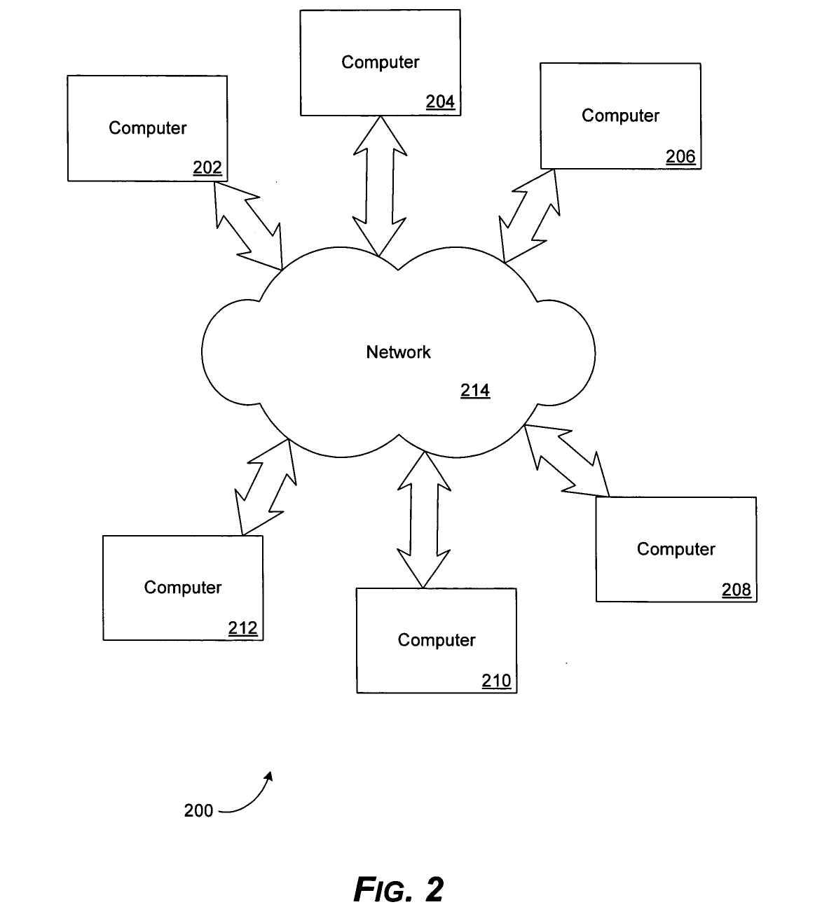

FIG. 2 illustrates an example networked computing environment 200 suitable for incorporating embodiments of the invention. The networked computing environment 200 includes computers 202, 204, 206, 208, 210 and 212 connected by a network 214. Each of the computers 202, 204, 206, 208, 210 and 212 may incorporate some or all of the features of the computer 102 (FIG. 1). In particular, each of the computers 202, 204, 206, 208, 210 and 212 may include a particular communication connection 126 to the network 214. In an embodiment of the invention, the network 214 enables each of the computers 202, 204, 206, 208, 210 and 212 to communicate with any of the other computers 202, 204, 206, 208, 210 and 212. Each of the computers 202, 204, 206, 208, 210 and 212 may act as one or more of a client, a server or a peer to each of the other computers 202, 204, 206, 208, 210 and 212. The network 214 may include one or more hubs, switches, routers, gateways or any suitable computer 102. The networked computing environment 200 may support a distributed computing environment.

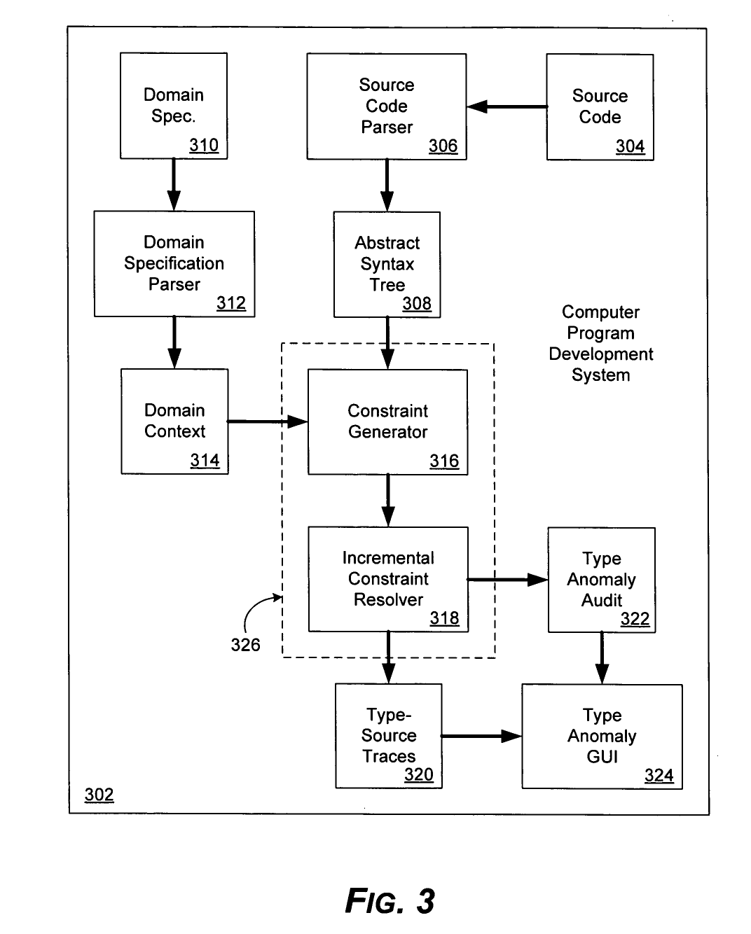

For clarity in describing a process of computer program development in accordance with an embodiment of the invention, a particular computer programming language, ECMAScript, is used consistently in examples below. See the “ECMAScript Language Specification,” ECMA-262, 3^{rd} edition, ECMA International, December 1999, for details of the ECMAScript programming language. However, as will be apparent to one of skill in the art, each embodiment of the invention is not so limited. A development process incorporating any suitable computer programming language may benefit from features of the invention. FIG. 3 depicts an example high level architecture for a computer program development system 302 in accordance with an embodiment of the invention that may be utilized by computer program developers as part of a computer program development process.

In the computer program development system 302, computer program source code 304 may be parsed by a source code parser 306 to produce an abstract syntax tree 308. In addition, a programmatic domain specification 310 may be parsed by a domain specification parser 312 to produce a domain context 314. The abstract syntax tree 308 corresponding to the source code 304 and the domain context 314 corresponding to the domain specification 310 may be input to a type constraint generator 316. The type constraint generator 316 may generate type constraints corresponding to the abstract syntax tree 308 and the domain context 314.

Constraints generated by the constraint generator 316 may be input to an incremental constraint resolver 318. The incremental constraint resolver 318 may incrementally resolve the constraints. During and/or subsequent to constraint resolution, the incremental constraint resolver 318 may generate one or more type-source traces 320 and a type anomaly audit 322. The type-source traces 320 and/or the type anomaly audit 322 may be graphically rendered by a type anomaly graphical user interface (GUI) 324. The dashed line 326 indicates that, in an embodiment of the invention, the constraint generator 316 and the incremental constraint resolver 318 may be integrally incorporated into a single computer program development system 302 component.

Arrows between components 304, 306, 308, 310, 312, 314, 316, 318, 320, 322 and 324 indicate a predominant direction of data flow. However, in an embodiment of the invention, data, message, signals, and particularly feedback may progress in a reverse direction, for example, to regulate data flow and/or data production. In addition, each component 304, 306, 308, 310, 312, 314, 316, 318, 320, 322 and 324 may be controlled and/or coordinated by the computer program development system 302 as described in more detail below.

For example, the source code 304 may include one or more text files containing one or more lines of the ECMAScript programming language. Each line of ECMAScript programming language may specify one or more programmatic elements such as constants, variables, objects, functions, operations, expressions and statements. The source code parser 306 may be generated from a grammar corresponding to the ECMAScript programming language, for example, by tools corresponding to conventional lexical analyzer generators and parser compilers (e.g., lex and yacc). Some computer programming languages, such as ECMAScript, have idiosyncratic (e.g., non-LALR compliant) grammars. In an embodiment of the invention, the parser generated by the conventional tools (e.g., an LALR parser) requires modification in a manner apparent to those of skill in the art before it can serve as the source code parser 306. Any suitable parser capable of parsing the source code 304 and producing the abstract syntax tree 308 may serve as the source code parser 306.

Computer programs may execute within one or more computing environments such as the computing environment 100 (FIG. 1). As described above with reference to FIG. 1 and FIG. 2, computing environments may vary widely, for example, from the minimal configuration 112 to heterogeneous distributed computing environments supported by the networked computing environment 200. Each computing environment may be associated with one or more programmatic interfaces for accessing features, functionality and/or capabilities of the computing environment. Very few computer programs execute completely independent of such programmatic interfaces, that is, such programmatic interfaces may make up part of a programmatic platform upon which new computer programs are developed.

As a result, compliance with computing standards specifying programmatic platforms may be as relevant to computer program reliability as compliance with computing standards specifying programming languages. In particular, the programmatic interfaces associated with programmatic platforms may specify one or more variables, functions, structures, messages, schemas, programmatic objects and/or the like, each associated with one or more types. The programmatic domain specification 310 may specify types associated with each such programmatic interface element, thus enabling checking for type consistency and/or anomaly.

When programmatic interfaces of programmatic platforms are specified with well-typed programming languages, the domain specification parser 312 may be similar to the source code parser 306, resulting in the domain context 314 being similar to the abstract syntax tree 308. However, in an embodiment of the invention, the domain specification 310 specifies type relationships for programmatic interface elements independent of a programmatic interface specification. For example, the domain specification 310 may be specified with a constraint specification language suitable for specifying type constraints corresponding to type constraints generated by the constraint generator 316.

Furthermore, the domain specification 310 may be specified with a programming language (or suitable subset thereof) utilized to implement the constraint generator 316 and/or the incremental constraint resolver 318. In this case, the domain specification parser 312 may correspond to a conventional parser of the programming language. This option may be selected if the programming language utilized to implement the constraint generator 316 has superior parsing and/or text processing facilities, for example, Perl, Python, or one of the ML family of programming languages. The domain context 314 may correspond to the abstract syntax tree 308, to be processed similarly by the constraint generator 316. Alternatively, the domain context 314 may correspond to data structures and/or programmatic objects partially or wholly similar to those representing constraints generated by the constraint generator 316, thus partially or wholly lightening the task load of the constraint generator 316.

Each node of the abstract syntax tree 308 may correspond to zero or more type constraints and/or contingent constraints. Illustrative examples of type constraints include “variable x is of type A,” “the type of object y is the same as the type of object z,” “compound type B includes an element of type C,” “variable w is one of {type D, type E, type F},” and any suitable relationship between types, sets of types, categories of types, compound types, variables and programmatic objects. Illustrative examples of contingent constraints include “variable x is conditionally of type A,” “the type of object y is conditionally the same as the type of object z,” “compound type B conditionally includes an element of type C,” “variable w is conditionally one of {type D, type E, type F},” “if event G occurs, then object p is further constrained and/or contingently constrained,” and any suitable contingent relationship between types, sets of types, categories of types, compound types, variables, programmatic objects, conditions, events, constraints and contingent constraints. Embodiments of the invention are not limited to these illustrative examples.

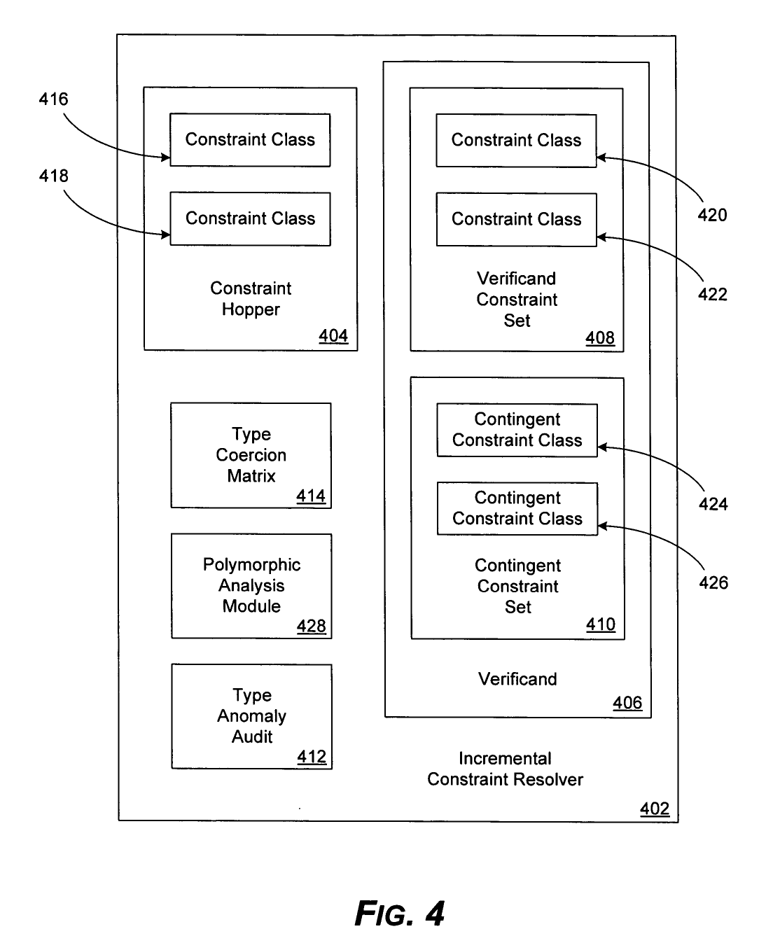

In an embodiment of the invention, each contingent constraint is associated with a condition that is true or false depending on a state of a verificand (an example verificand is described below in more detail with reference to FIG. 4). So that, for example, the contingent constraint “variable x is conditionally of type A” may correspond to “if condition H is true in the verificand, then variable x is of type A.” Similarly, the condition “if event G occurs” may correspond to “if condition J is true in the verificand.”

The constraint generator 316 may recursively visit each node of the abstract syntax tree 308. The constraint generator 316 may determine and instantiate the zero or more constraints and/or contingent constraints corresponding to each node of the abstract syntax tree 308. For example, if a particular node of the abstract syntax tree 308 corresponds to an assignment operator with child nodes corresponding to variables x and w, then the constraint generator 316 may generate the constraint “the type of variable x is the same as the type of variable w.”

When the abstract syntax tree 308 corresponds to source code 304 written in a programming language not explicitly designed for type inference, it may not be possible for the constraint generator 316 to generate unconditional type constraints at nodes of the abstract syntax tree 308 even when useful type constraint information is available. In an embodiment of the invention, the constraint generator 316 may instead generate one or more contingent constraints that capture the available type constraint information. Examples of contingent constraints and contingent constraint generation scenarios are described below in more detail.

As described above, when the structure of the domain context 314 corresponds to the structure of the abstract syntax tree 308, constraints and contingent constraints may be generated by the constraint generator 316 in a like manner. Otherwise, some or all of the domain context 314 may be incorporated by the constraint generator 316 into the set of generated constraints and contingent constraints, and the remainder requiring processing corresponding to that for the abstract syntax tree 308, although the “nodes” of the domain context 314 need not be organized in a tree. The generated set of constraints and contingent constraints may be provided to the incremental constraint resolver which is described below in more detail with reference to FIG. 4.

FIG. 4 depicts an example incremental constraint resolver 402 in accordance with an embodiment of the invention. The incremental constraint resolver 402 may include a constraint hopper 404 and a verificand 406. The verificand 406 may include a verificand constraint set 408 and a contingent constraint set 410. Type constraints, for example, generated by the constraint generator 316 (FIG. 3), may be loaded into the constraint hopper 404 for processing. Contingent constraints, for example, generated by the constraint generator 316, may be added to the contingent constraint set 410 of the verificand 406. The verificand constraint set 408 may begin empty. This initial state of the verificand 406 may correspond to a state of only contingent knowledge with respect to relationships between variable and/or programmatic object types referenced by the source code 304.

Constraints in the constraint hopper 404 may be added incrementally to the verificand constraint set 408. Following each addition, the verificand constraint set 408 may be unified. For example the verificand constraint set 408 may be unified with a unification computation in accordance with that described in Robinson, J. Alan., “Computational logic: The unification computation,” Machine Intelligence, 6:63-72, 1971. Unification may enable detection of new relationships between types (i.e., type inference), inconsistencies between types, and/or events that activate contingent constraints in the contingent constraint set 410. Detected new relationships between types may contribute to type-source traces 320 (FIG. 3). Detected inconsistencies between types may contribute to the type anomaly audit 322. Detected contingent constraint activation events may activate contingent constraints in the contingent constraint set 410. Activation of contingent constraints may result in additions of new constraints to the verificand constraint set 408, additions of new contingent constraints to the contingent constraint set 410 and/or deletion of existing contingent constraints from the contingent constraint set 410. After each addition of constraints from the constraint hopper 404, the verificand 406 may progress to a stable state (e.g., such that further unifications leave the verificand unchanged) before further constraints are added from the constraint hopper 404.

Each computer programming language typically has one or more fundamental or primitive types from which others are constructed. For example, fundamental types of ECMAScript include Boolean, Number, String and Object. As the constraint hopper 404 is emptied and the verificand 406 is progressed, relationships between named or identified types and the fundamental types may be established. For example, constraints “type A=Boolean,” “type B=type C,” and “type C=type A” may be added to the verificand constraint set 408 from the constraint hopper 404. Following unification, “type B=type C=type A=Boolean”, it is established that each of type A, type B and type C is constrained to the fundamental Boolean type.

To continue the example, suppose a further constraint “type A=Number” is added to the verificand constraint set 408 from the constraint hopper 404. Such a constraint is inconsistent with the current state of the verificand 406, indicating that the source code 304 (FIG. 3) includes inconsistencies and that a computer program resulting from the source code 304 may include sources of error, indeterminacy and/or unreliability. Accordingly, a corresponding type mismatch entry may be made in a type anomaly audit 412. When the constraint hopper 404 is empty and the verificand 406 is complete, the type anomaly audit 412 may become the type anomaly audit 322 (FIG. 3) that is provided to the type anomaly GUI 324.

Each constraint in the constraint hopper 404 may be associated with a particular location in the source code 304 (FIG. 3). For example, a specification of each source code location may include a pair of line and column coordinates corresponding to a particular character in a text file containing one or more lines of the ECMAScript programming language. In an embodiment of the invention, the specification of each source code location (the location-tuple) further includes a unique identifier such as a universally unique identifier (UUID), for example, to disambiguate multiple constraints corresponding to a same line and column coordinate in a particular text file. A text file identifier, for example, a file system path, a uniform resource locator (URL), or a uniform resource name (URN), may also be an element of the location-tuple.

Such location information may be incorporated into the abstract syntax tree 308 by the source code parser 306, may persist in the constraints and contingent constraints generated by the constraint generator 316, and may be preserved in the verificand 406 by the incremental constraint resolver 318 during incremental resolution. As a result, the completed verificand 406 may include one or more type-source traces tracing each identified type to, for example, a fundamental type or object constructor, as well as tracing those source code 304 locations that correspond to the links of the trace. Each type-source trace may correspond to a graph including nodes corresponding to types and edges corresponding to source code 304 locations associated with the types. Each pair of nodes in the graph may be connected with any suitable number of edges, including zero.

Continuing the example still further, and using simplified identifiers for clarity, constraints in the constraint hopper 404 may each be associated with one or more locations: “type A=[1] Boolean,” “type B=[2] type C,” “type C=[3] type A,” and “type A=[4] Number.” The resultant verificand constraint set 408 may preserve the location information: “type B=[2] type C=[3] type A=[1] Boolean,” and “type A=[4] Number.” The resultant type-source trace in the verificand constraint set 408, for example, displayed with the type anomaly GUI 324 (FIG. 3), may reveal to a computer program development system 302 user locations at which the source code 304 is consistent and inconsistent, thus enabling corrective action by the user prior to deployment of the computer program.

In an embodiment of the invention, having detected a type mismatch, the incremental constraint resolver may continue processing the verificand by recording the mismatch, for example, in the type anomaly audit 412, and introducing new unconstrained types in place of the offending identified types, i.e., introducing free type variables. In the example, the overconstrained identified type A in the “type A=Number” constraint may be replaced with a new free type Z to yield the innocuous “type Z=Number” and a particular mismatch “type A=type Z” entry made in the type anomaly audit 412. In contrast to conventional type inference systems, type inconsistencies need not prevent assemblage of as complete information as possible with respect to type relationships for given source code 304 (FIG. 3).

Some detected type mismatches may be between types that, with respect to a particular programming language, programming environment and/or programming culture, are permitted, or even expected, to be automatically reconciled. For example, it may be that ECMAScript programmers expect, upon encountering a type mismatch between a Number and a Boolean, that the offending Boolean be automatically coerced to a Number (but not vice versa). In an embodiment of the invention, the incremental constraint resolver 402 includes a type coercion matrix 414 that may specify allowed type coercions, type coercion direction, type coercion behavior and/or whether the type coercion should be reported, for example, in the type anomaly audit 412. When automatic type coercions are allowed, a consistency with respect to type coercion direction and type coercion behavior may assist the computer program development system 302 (FIG. 3) user attempting to diagnose computer program trouble.

Constraints and contingent constraints generated by the constraint generator 316 (FIG. 3) may be classified into one or more constraint and contingent constraint classes. For example, constraints corresponding to the source code 304 and constraints corresponding to the domain specification 310 may belong to different constraint classes. The constraint hopper 404, the verificand constraint set 408 and the contingent constraint set 410 of the incremental constraint resolver 402 each show two different constraint classes 416, 418, 420, 422 or two contingent constraint classes 424, 426. However, each embodiment of the invention is not so limited. Any suitable number of constraint classes and/or contingent constraint classes may be employed. In particular, different constraint classes may have different activation effects with respect to different contingent constraint classes. In addition, constraints and/or contingent constraints may be classified according to priority. For example, high priority constraints may receive additional processing and/or reporting, and/or low priority constraints may be processed and/or reported more efficiently including not being reported at all.

In computer programming languages that include type polymorphism, additional indeterminacy may arise, particularly with respect to parametric polymorphism. Some programming languages, such as ECMAScript, incorporate type polymorphism without requiring explicit invocation of the feature by computer programmers. Indeterminacies associated with polymorphism may result in contingent constraints that require polymorphic analysis (e.g., identification of monomorphic cases). In an embodiment of the invention, the incremental constraint resolver 402 includes a polymorphic analysis module 428 to provide such analysis.

Having described the computer program development system 302 and associated system components, procedures that may be performed by the system 302 and its components are now described in more detail.

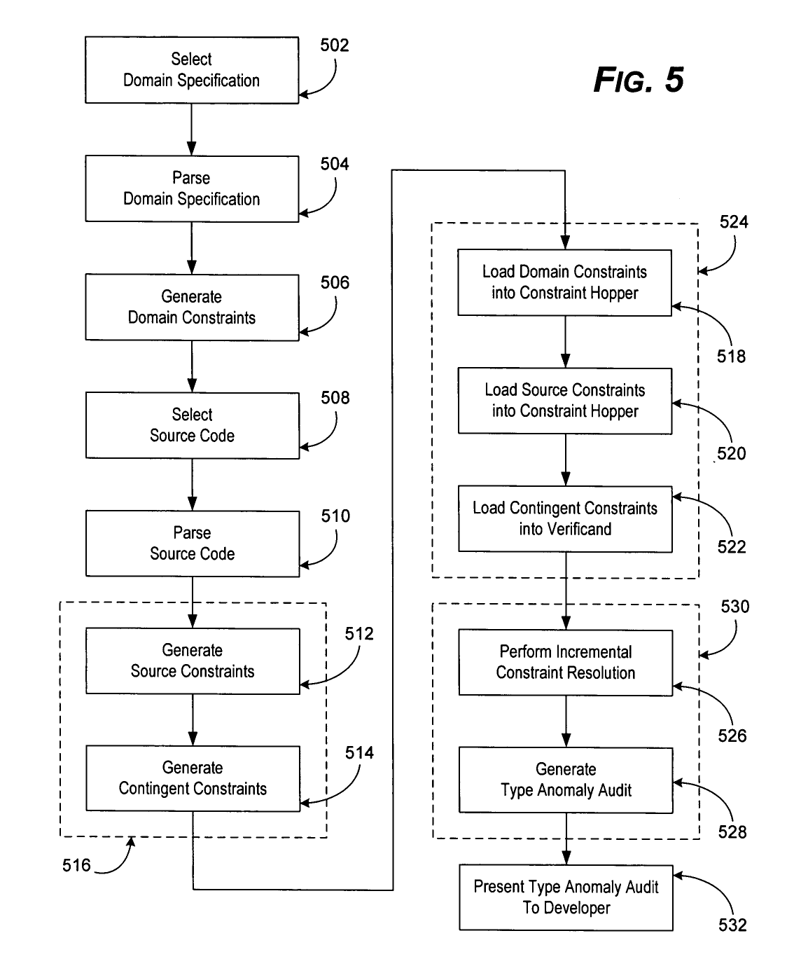

FIG. 5 depicts example steps for incremental type inferencing in accordance with an embodiment of the invention. One or more sets of source code such as source code 304 (FIG. 3) may be intended to result in one or more computer programs to be deployed on one or more programmatic platforms each associated with a programmatic domain specification such as the domain specification 310. At step 502, one of the programmatic domain specifications may be selected. For example, the programmatic domain specification may be selected by the computer program development system 302 user with the type anomaly GUI 324. The steps depicted in FIG. 5 may be repeated for each programmatic domain specification associated with an intended deployment platform.

At step 504, the selected programmatic domain specification may be parsed, for example, by the domain specification parser 312 (FIG. 3) of the computer program development system 302. In an embodiment of the invention, the parsed programmatic domain specification is suitable for corresponding constraint generation. At step 506, domain constraints corresponding to the parsed programmatic domain specification may be generated, for example, by the constraint generator 316. In the example depicted in FIG. 5, the nature of programmatic domain specifications is such that contingent constraints are not required to represent corresponding type relationships. For example, the programmatic domain specification selected at step 502 may correspond to a document object model (DOM) compatible with ECMAScript, such as the DOM described by Apparao et al., “Document Object Model (DOM) Level 1 Specification,” REC-DOM-Level-1-19981001, World Wide Web Consortium (W3C), October, 1998.

At step 508, one of the sets of source code may be selected. For example, the source code may be selected by the computer program development system 302 (FIG. 3) user with the type anomaly GUI 324. The steps depicted in FIG. 5 may be likewise repeated for each set of source code to be deployed. At step 510, the selected source code may be parsed, for example, by the source code parser 306. In an embodiment of the invention, the parsed source code is suitable for corresponding constraint and contingent constraint generation At step 512, source constraints corresponding to the parsed source code may be generated, for example, by the constraint generator 316. At step 514, contingent constraints corresponding to the parsed source code may be generated, for example, by the constraint generator 316. Dashed line 516 indicates that, in an embodiment of the invention, steps 512 and 514 may be incorporated into a single step that generates both constraints and contingent constraints in an integral manner, for example, during a single abstract syntax tree 308 traversal.

At step 518, the domain constraints generated at step 506 may be loaded into the constraint hopper 404 (FIG. 4) of the incremental constraint resolver 402. At step 520, the source constraints generated at step 512 may also be loaded into the constraint hopper 404. In an embodiment of the invention, the domain constraints in the constraint hopper 404 are classified into a first constraint class 416 and the source constraints in the constraint hopper 404 are classified into a second constraint class 418. At step 522, the contingent constraints generated at step 514 may be loaded into the contingent constraint set 410 of the verificand 406. Dashed line 524 indicates that, in an embodiment of the invention, steps 518, 520 and 522 may be incorporated into a single step that loads each generated constraint and contingent constraint into the incremental constraint resolver 402 in an integral manner.

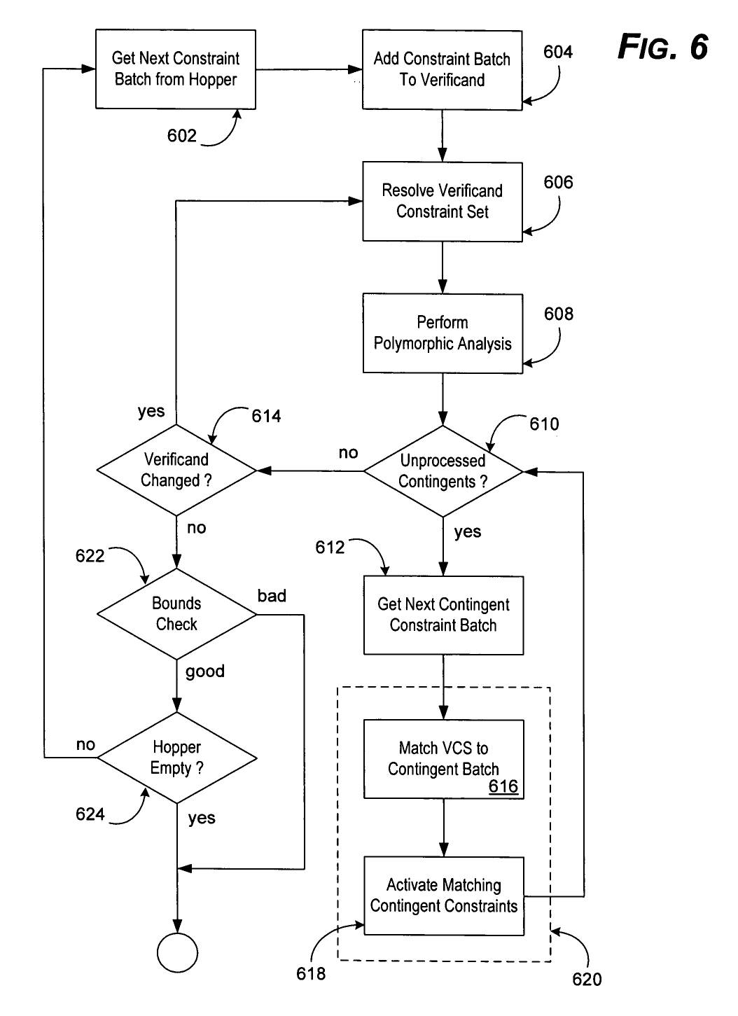

At step 526, incremental constraint resolution may be performed by repeatedly adding constraints from the constraint hopper 404 (FIG. 4) to the verificand 406 and then resolving the verificand 406 until it becomes stable. The process of verificand 406 resolution is described below in more detail with reference to FIG. 6. As described above, the process of verificand 406 resolution may result in mismatch entries in the type anomaly audit. In addition, once each constraint in the constraint hopper 404 has been added to the verificand 406, it may be determined that one or more identified types are not constrained to any fundamental and/or known type, that is, one or more identified types may be undetermined. Such a determination may indicate that the source code 304 (FIG. 3) includes indeterminacies and that a computer program resulting from the source code 304 may include sources of error and/or unreliability. Accordingly, corresponding unknown type entries may be made in the type anomaly audit 412.

At step 528, the type anomaly audit 322 (FIG. 3) may be generated, for example, from the type anomaly audit 412 (FIG. 4). Similar and/or related type anomaly audit 412 entries may be sorted and/or grouped. For example, entries may be related by location-tuple, correspondence to abstract syntax tree nodes, and/or associated types. The number of entries may be reduced, for example, duplicate entries may be suppressed, entries related to programming language idiosyncrasies may be suppressed, and/or a single entry may be selected to report an anomaly having multiple related entries. Dashed line 530 indicates that, in an embodiment of the invention, steps 526 and 528 may be incorporated into a single step in which generation of the type anomaly audit 322 is integral to incremental constraint resolution. At step 532, the type anomaly audit 322 may be presented to the computer program developer, for example, with the type anomaly GUI 324.

FIG. 6 depicts example steps for incremental constraint resolution in accordance with an embodiment of the invention. For example, the steps depicted in FIG. 6 may be performed by the incremental constraint resolver 402 (FIG. 4). At step 602, a next (or first) batch of constraints may be removed from the constraint hopper 404 (FIG. 4) and, at step 604, added to the verificand constraint set 408. In an embodiment of the invention, the number of constraints in the batch (i.e., the constraint batch size) is one. However, each embodiment of the invention is not so limited. The constraint batch may be any suitable size. The constraint batch size need not be the same for each performance of step 602. Furthermore, selection of constraints for the batch may be prioritized and/or weighted according to constraint class.

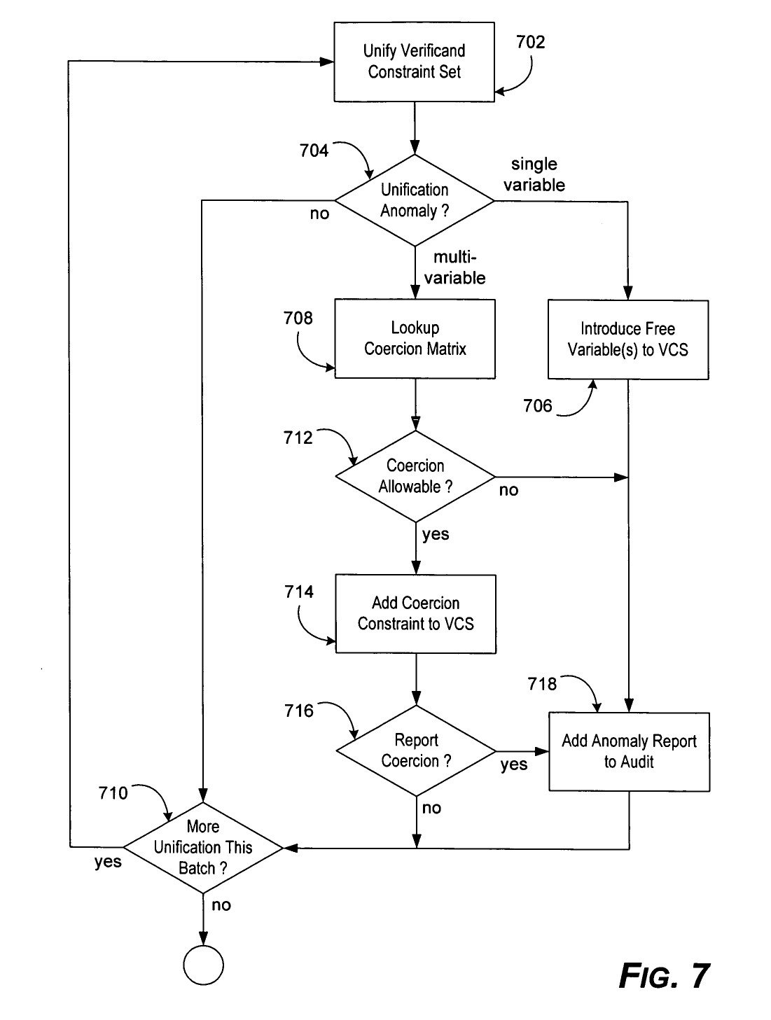

At step 606, the newly increased verificand constraint set 408 (FIG. 4) may be resolved. Resolution of the verificand constraint set 408 in accordance with an embodiment of the invention is described below in more detail with reference to FIG. 7. Following resolution of the verificand constraint set 408, the verificand constraint set 408 may include one or more unified type-source traces, and, in an embodiment of the invention, any type mismatches caused by the addition of the constraint batch at step 604 will have been resolved with type coercion and/or by introduction of free type variables.

At step 608, conventional polymorphic analysis may be performed with respect to the verificand constraint set 408. For example, the polymorphic analysis may be performed by the polymorphic analysis module 428 (FIG. 4). In particular, the newly resolved verificand constraint set 408 may be able to provide additional information to enable identification of monomorphic types thus enabling activation of one or more contingent constraints in the contingent constraint set 410.

Following each performance of step 606, new information may have become available for the activation of contingent constraints, that is, new contingent constraint activation events may have occurred. As a result, some or all of the contingent constraint set 410 (FIG. 4) may need checking for activation. At step 610, it may be determined if there are contingent constraints that require checking for activation. If there are contingent constraints that require checking for activation, the procedure may progress to step 612. Otherwise, the procedure may progress to step 614.

At step 612, a next (or first) contingent constraint batch may be selected for checking, for example, from the contingent constraint set 410 (FIG. 4). In an embodiment of the invention, the number of contingent constraints in the batch (i.e., the contingent constraint batch size) is one. However, each embodiment of the invention is not so limited. The contingent constraint batch may be any suitable size including, for example, the entire contingent constraint set 410. The contingent constraint batch need not be the same for each performance of step 612. Furthermore, selection of contingent constraints for the batch may be prioritized and/or weighted according to contingent constraint class. In an embodiment of the invention, contingent constraints are processed in an order that minimizes a number of iterations through one or more of the loops depicted in FIG. 6.

At step 616, the contingent constraint batch may be checked for activation by constraints in the verificand constraint set (VCS) 408 (FIG. 4), that is, contingent constraints in the contingent constraint batch may be matched to contingent constraint activations events generated by verificand constraint set 408 resolution. In an embodiment of the invention, each contingent constraint in the contingent constraint batch selected at step 612 is checked in turn against each constraint in the verificand constraint set 408. As will be appreciated by one of skill in the art, the contingent constraints in the contingent constraint batch may be considered as filters with respect to constraint “events” in the verificand constraint set 408 so that any suitable conventional filtering and/or event matching mechanism may be utilized to match constraints in the verificand constraint set 408 to contingent constraints in the contingent constraint batch.

At step 618, those contingent constraints in the contingent constraint batch that did match constraints in the verificand constraint set 408 (FIG. 4) may be activated. As described above with reference to FIG. 4, activation of contingent constraints may result in modification to the verificand constraint set 408 and/or the contingent constraint set 410. Example contingent constraints, contingent constraint classes and consequences of contingent constraint activation are described in more detail below. Dashed line 620 indicates that, in an embodiment of the invention, steps 616 and 618 are incorporated into a single step that both matches and activates contingent constraints in an integral manner.

Following activation of any matching contingent constraints, the procedure may return to step 610 to determine if there are more candidate contingent constraints to be checked. If not, then the procedure may progress to step 614. At step 614, it may be determined if the verificand 406 (FIG. 4) has changed since the most recent resolution step 606, for example, due to contingent constraint activation. If the verificand 406 has changed, then the procedure may return to step 606 for further verificand resolution. Otherwise, the procedure may progress to step 622.

At step 622, a resolution process bounds check may occur. Any suitable bounds check may be utilized by step 622 including comparison of elapsed time, number of cycles, verificand constraint set size and contingent constraint set size with configurable thresholds as well as conventional deadlock condition detection. If the bounds check succeeds, the procedure may progress to step 624. Otherwise, the procedure depicted by FIG. 6 may exit, for example, by raising a programmatic exception.

At step 624, it may be determined if the constraint hopper 404 (FIG. 4) is empty or if there are more constraints to be added to the verificand 406. If the constraint hopper 404 is empty, then incremental constraint resolution has successfully completed and the procedure depicted by FIG. 6 may exit. If there are more constraints to be added to the verificand, then the procedure may return to step 602 to select the next candidate batch.

FIG. 7 depicts example steps for verificand constraint set 408 (FIG. 4) resolution in accordance with an embodiment of the invention. For example, the steps depicted in FIG. 7 may be performed by the incremental constraint resolver 402. Step 702 may occur after a step corresponding to step 604 (FIG. 6) at which a particular batch of new constraints has been added to the verificand constraint set 408. At step 702, unification of the verificand constraint set may be performed, for example, conventional constraint unification such as occurs in Hindley-Milner type inference. In an embodiment of the invention, unification of the verificand constraint set 408 includes sorting and/or grouping similar and/or related constraints to enable aggregate deductions, resulting in more efficient unification.

The unification of step 702 may result in exceptions and/or anomalies. At step 704, it may be determined if a unification anomaly has occurred and a type of any such anomaly. Types of unification anomaly may include anomalies involving a single type variable and anomalies involving multiple type variables. An example of a single type variable unification anomaly is the addition of the constraint “type A=Number” to a verificand constraint set 408 (FIG. 4) that already includes the constraint “type A=Boolean.” An example of a multi-variable unification anomaly is the addition of the constraint “type A=type B” to a verificand constraint set 408 that already includes the constraints “type A=Number,” and “type B=Boolean.”

In an embodiment of the invention, coercion is not an option for single type variable unification anomalies and the procedure may progress to step 706. If the unification anomaly is determined to be a multi-variable anomaly, the procedure may progress to step 708 to determine if coercion is appropriate. If no anomaly has occurred the procedure may progress to step 710 to check if further unification is required with respect to the present constraint batch.

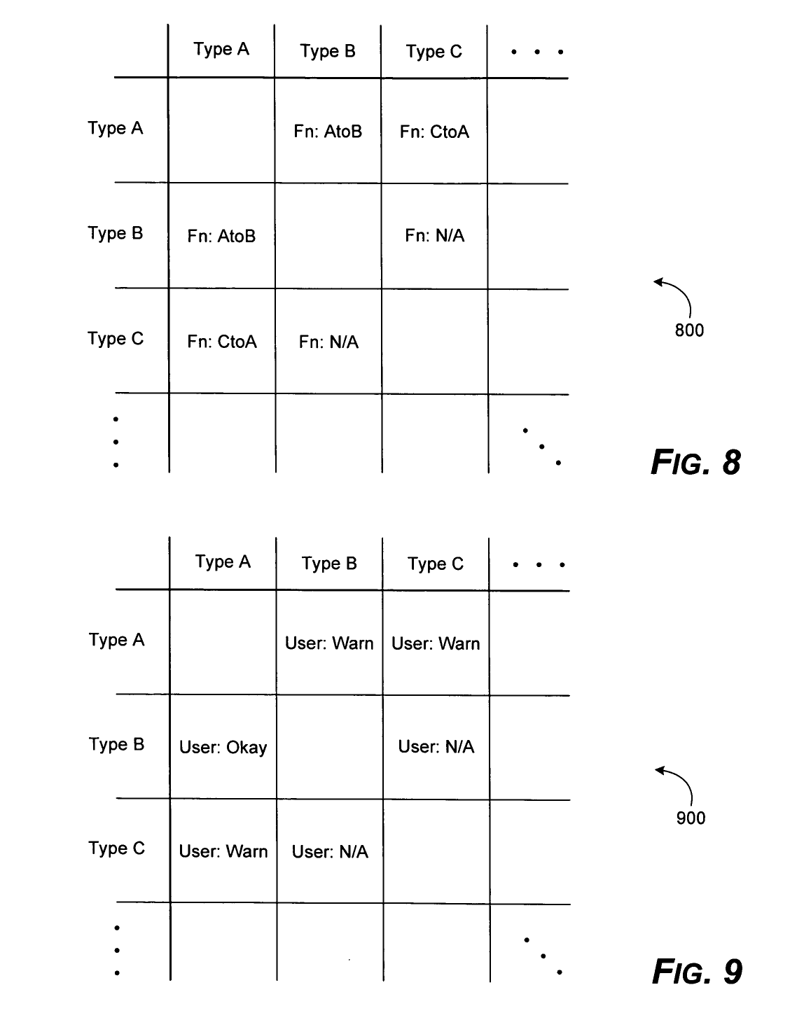

At step 708, the type coercion matrix 414 (FIG. 4) may be checked with respect to the mismatching types causing the unification anomaly. FIG. 8 illustrates an example element 800 of the type coercion matrix 414 in accordance with an embodiment of the invention. Checking the type coercion matrix 414 element 800 with respect to two mismatching types involves looking-up the intersection of the two types. For example, if the two mismatching types are type A and type B, a coercion function “AtoB” is available for coercing type A into type B, if the two mismatching type are type A and type C then a coercion function “CtoA” is available for coercing type C into type A, however if the two mismatching types are type B and type C then no suitable function is available for type coercion. Element 800 need not be symmetrical with respect to mismatching types, that is, when the coercion function is available in one direction for a given pair of mismatching types, it need not be available for the reverse direction.

At step 712, it may be determined if coercion is allowable for the mismatching types causing the unification anomaly, for example, in accordance with the availability of a coercion function as determined at step 708. If coercion is allowable, the procedure may progress to step 714. Otherwise, the procedure may progress to step 718.

At step 706, one or more free type variables may be introduced into the verificand constraint set 408 (FIG. 4), for example, as described above with reference to FIG. 4. At step 714, one or more constraints corresponding to the coercion function indicated by type coercion matrix 414 element 800 may be added to the verificand constraint set 408. In each case the introduction of additional constraints to the verificand constraint set 408 may make further unification possible, that is, the additional constraints may compensate for the unification anomaly.

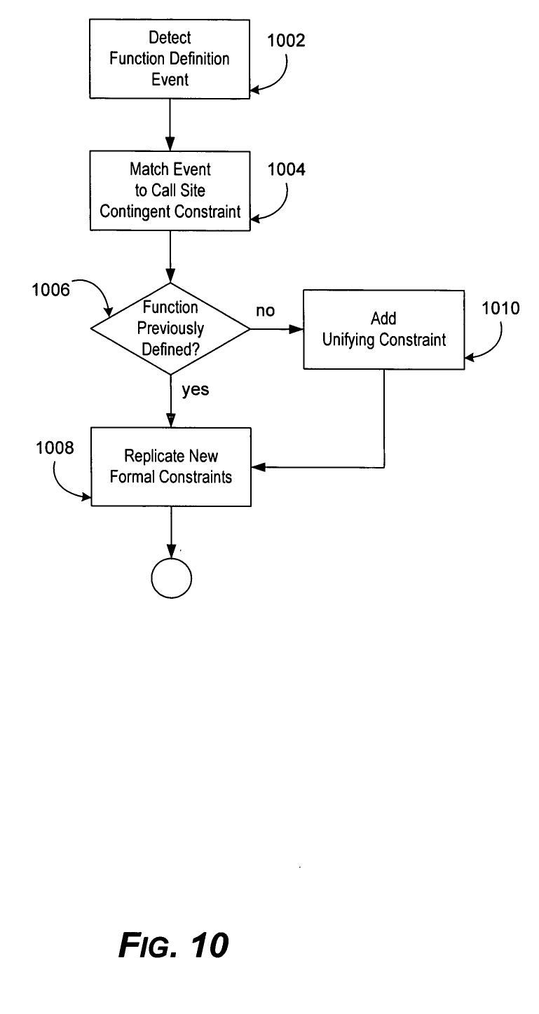

At step 716, it may be determined if the coercion of step 714 should be reported, for example, a corresponding entry added to the type anomaly report 412 (FIG. 4). Some coercions are so common and/or expected that corresponding entries in the type anomaly report 412 may be considered disinformation or, at least, distracting from more significant entries. Accordingly, the computer program development system 302 (FIG. 3) user may configure coercion reporting preferences. FIG. 9 illustrates another example element 900 of the type coercion matrix 414 in accordance with an embodiment of the invention. Again, determining if the coercion step 714 should be reported involves looking-up the intersection of two coerced types. For example, if a type A was coerced to a type B, then no report is required, however if a type C was coerced to a type A, then the user has request that a warning entry be made in the type anomaly report 412. As before some coercions, such as from a type C to a type B may not be available. Again, the type coercion matrix 414 element 900 need not be symmetrical with respect to indexed types. A coercion in one direction may result in a type anomaly report 412 entry, while a coercion in the other direction may not.

If it is determined that the coercion of step 714 should be reported, then the procedure may progress to step 718. Otherwise, the procedure may progress to step 710. At step 718, an entry may be made in the type anomaly audit 412 (FIG. 4) corresponding to the unification anomaly detected at step 704 and the resultant facilitatory action, i.e., step 706 or step 714. At step 710, it may be determined if further unification is required with respect to the present constraint batch. If further unification is required, the procedure may return to step 702. Otherwise, the procedure may exit.

Particular examples of contingent constraints are now described. In an embodiment of the invention, contingent constraints are instantiated in response to indeterminacies in source code 304 (FIG. 3) programming language statements. Once incremental constraint resolution (e.g., step 526 of FIG. 5) is complete, it may be that all relevant indeterminacies are resolved, however, during constraint generation (e.g., step 516 of FIG. 5) and/or the incremental resolution process (e.g., the steps depicted in FIG. 6) several sources of indeterminacy may be encountered, depending on the programming language.

For example, in some programming languages, a type of a result of an operation or function may depend upon a type of one or more parameters of the operation or function. The type of each parameter, and thus the type of the operation or function, may be different at each site in the source code 304 (FIG. 3) at which the operation or function is applied or called, that is, at each “call site.” The formal operation or function type and the type of its formal parameters may be defined in the verificand constraint set 408 (FIG. 4) with one or more constraints and/or contingent constraints, that is, formal constraints and/or contingent constraints. Furthermore, in an embodiment of the invention, when a particular application of an operation or a particular call to a function is encountered, for example, during the constraint generation step 516 (FIG. 5), one or more call site contingent constraints may be instantiated for the operation or function. The call site contingent constraints may be activated as information about the operation or function definition comes to light during incremental constraint resolution.

As an example of contingent constraint activation, FIG. 10 depicts example steps for activating a call site contingent constraint in accordance with an embodiment of the invention. At step 1002, a function definition event may be detected. For example, one or more constraints in a particular constraint batch that are associated with the call site contingent constraint may be added to the verificand constraint set 408 (FIG. 4). In particular, the added constraint(s) may create and/or update an operation or function definition in the verificand constraint set 408 referenced by the call site contingent constraint. At step 1004, the detected function definition event may be matched to the call site contingent constraint. For example, one or more of type identifiers referenced by the constraint(s) triggering the event and the call site contingent constraint may match.

At step 1006, it may be determined if the operation or function associated with the triggering event has been previously defined in the verificand constraint set 408 (FIG. 4). If the operation or function has been previously defined then the procedure may progress to step 1008. Otherwise, the procedure may progress to step 1010.

At step 1008, each new formal constraint associated with the updated operation or function definition may be replicated, for example, a duplicate formal constraint may be added to the verificand constraint set 408 (FIG. 4). Formal contingent constraints may also be replicated at step 1008, however, in an embodiment of the invention, such contingent constraints replicate themselves when activated if they determine that replication is required.

At step 1010, a call site unifying constraint may be added to the verificand constraint set 408 (FIG. 4). The particular instance of the operation or function and its parameters at the call site associated with the call site contingent constraint may be specified in the verificand constraint set 408 by one or more actual (as contrasted with formal) constraints and/or contingent constraints. The call site unifying constraint may associate the formal constraint replica with the actual constraints, for example, the actual constraints may be equated with the formal constraint replica.

The new constraints generated by the call site contingent constraint may each be later unified with other constraints of the verificand constraint set 408 (FIG. 4). For example, during incremental resolution, polymorphic analysis may determine that one or more of the formal parameters of a particular operation or function definition are monomorphic, so that each corresponding constraint replica generated by associated call site contingent constraint(s) correspond to each other. In an embodiment of the invention, the monomorphic determination results in an addition of one or more constraints to the verificand constraint set 408 which unify each corresponding generated constraint in accordance with the determination, in effect “undoing” the corresponding replication. Such mechanisms make it possible for incremental type inference in accordance with an embodiment of the invention to assume initially that each suitable operation or function definition is parametrically polymorphic until shown otherwise without invalidation of the verificand 406 during resolution.

A related source of indeterminacy in programming languages is operator and function overloading of various kinds. For example, the binary addition (‘+’) operator may be overloaded to return a String type if its parameters are both strings, or a Number type if its parameters are both numbers. However, the return type of a particular instance of the operator cannot be determined until the types of its parameters are determined. When the operator or, more generally, any suitable overloaded function is encountered, an overload contingent constraint may be generated. If, during incremental resolution, a particular overload signature is detected, a new constraint specifying the return type of the overloaded function instance may be added to the verificand constraint set 408 (FIG. 4). If, at the conclusion of incremental resolution, the overload contingent constraint has not been activated, then a corresponding entry may be added to the type anomaly audit 412.

Another overload-related indeterminacy in some programming languages, particularly object-oriented programming languages, arises from the dot operator used to access attributes and methods of a programmatic object. For example, in ECMAScript, the f in the expression “obj.f” may or may not be a function. If it is a function, then the “self type” of the function should be compatible with the type of the invoking object obj, i.e., the two should be related with a particular constraint. Until a determination can be made, during incremental resolution, as to whether f is a function, a function self overload contingent constraint may be instantiated to include the ambiguity in the verificand 406 (FIG. 4).

Some programming languages include scoping operators that can be a source of indeterminacy. For example, ECMAScript includes the “with” scoping operator that explicitly ambiguates each object in its scope. In the scope of a “with obj” statement, the expression “g=2” can mean “g=2” or “obj.g=2” depending on whether g is defined independent of the “with” operator. Until the type of g can be resolved, a scoping overload contingent constraint may be instantiated to include the indeterminacy in the verificand 406 (FIG. 4).

Object construction is another potential source of indeterminacy in programming languages. For example, in ECMAScript, the type of the result of the “new” operator depends upon the type returned by a parameter of the operator. The expression “new h( )” may correspond to different types depending upon the return type of the function h. Again, until the return type of h can be resolved, a constructor contingent constraint may be instantiated to include the indeterminacy in the verificand 406 (FIG. 4).

In addition to general types of contingent constraint, some contingent constraints may be specific to a particular programming language. For example, in ECMAScript, if a particular programmatic object has a “prototype” property and the object is a function, then the prototype property may be a source of indeterminacy. If the function with the prototype property is used as a constructor, then the prototype property may determine, at least in part, the type of constructed objects. However, during constraint generation, it need not be the case that sufficient information is available to determine if a particular programmatic object having the prototype property definitely is or is not a function. In an embodiment of the invention, a contingent constraint may be instantiated for specifying a constraint on the type of constructed objects should sufficient information become available during incremental constraint resolution to make the determination.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. At least one computer-readable medium having thereon computer-executable instructions for incremental type inference comprising:
parsing source code specifying a plurality of programmatic elements in a programming language;
generating at least one type constraint corresponding to ones of the plurality of programmatic elements; and
incrementally resolving said at least one type constraint to infer a type of at least one of the plurality of programmatic elements.

2. Said at least one computer-readable medium of claim 1, wherein the computer-executable instructions further comprise generating at least one contingent constraint corresponding to ones of the plurality of programmatic elements.

3. Said at least one computer-readable medium of claim 2, wherein:
the computer-executable instructions further comprise:
loading said at least one type constraint into a constraint hopper; and
loading said at least one contingent constraint into a verificand; and
incrementally resolving said at least one type constraint comprises repeatedly:
removing a batch of constraints from the constraint hopper;
adding the batch of constraints to a constraint set of the verificand; and
resolving the constraint set of the verificand.

4. Said at least one computer-readable medium of claim 2, wherein incrementally resolving said at least one type constraint comprises:
resolving said at least one type constraint;
matching said at least one type constraint to at least one of said at least one contingent constraint; and
activating each matching contingent constraint.

5. Said at least one computer-readable medium of claim 2, wherein:
said at least one type constraint is in a constraint set of a verificand;
said at least one contingent constraint is in a contingent constraint set of the verificand; and
incrementally resolving said at least one type constraint comprises:
(a) resolving the constraint set of the verificand;
(b) matching the constraint set of the verificand to the contingent constraint set of the verificand;
(c) activating each matching contingent constraint; and
(d) if step (c) changes the verificand, repeating steps (a), (b) and (c) until the verificand is unchanged by step (c).

6. Said at least one computer-readable medium of claim 1, wherein the computer-executable instructions further comprise:
parsing a domain specification; and
generating at least one type constraint corresponding to the domain specification.

7. At least one computer-readable medium having thereon computer-executable instructions for generating a type anomaly audit comprising:
repeatedly:
adding at least one type constraint to a constraint set; and
unifying the constraint set; and
for at least one unification anomaly, adding an entry to the type anomaly audit.

8. Said at least one computer-readable medium of claim 7, wherein the computer-executable instructions further comprise, for each unification anomaly, adding at least one further type constraint to the constraint set to compensate for the unification anomaly.

9. Said at least one computer-readable medium of claim 8, wherein the computer-executable instructions further comprise, for at least one unification anomaly, checking a type coercion matrix to determine if a coercion function is available to compensate for the unification anomaly.

10. Said at least one computer-readable medium of claim 9, wherein the computer-executable instructions further comprise:
if the coercion function is available, checking the type coercion matrix to determine if the compensation should be reported; and
if the compensation should be reported, adding a corresponding entry to the type anomaly audit.

11. A computer program development system comprising:
a source code parser configured to, at least, parse source code specifying a plurality of programmatic elements in a programming language;
a type constraint generator configured to, at least, generate at least one type constraint corresponding to ones of the plurality of programmatic elements; and
an incremental type constraint resolver configured to, at least, incrementally resolve said at least one type constraint to infer a type of at least one of the plurality of programmatic elements.

12. The system of claim 11, wherein the type constraint generator is further configured to, at least, generate at least one contingent constraint corresponding to ones of the plurality of programming objects.

13. The system of claim 12, wherein each of said at least one contingent constraint corresponds to an indeterminacy of the programming language.

14. The system of claim 12, wherein the type constraint generator is further configured to, at least, classify each type constraint as at least one of a plurality of type constraint classes.

15. The system of claim 11, wherein:
the computer program development system further comprises a domain specification parser configured to, at least, parse a domain specification; and
the type constraint generator is further configured to, at least, generate at least one type constraint corresponding to the domain specification.

16. The system of claim 15, wherein the type constraint generator is further configured to, at least:
classify each type constraint corresponding to ones of the plurality of programmatic elements as a first type constraint class; and
classify each type constraint corresponding to the domain specification as a second type constraint class.

17. The system of claim 11, wherein:
the specification of each programmatic element is associated with at least one source code location;
the type constraint generator is further configured to, at least, associate each generated type constraint with said at least one source code location of said ones of the plurality of programmatic element to which the generated type constraint corresponds; and
incremental resolution preserves source code location associations enabling the incremental type constraint resolver to provide at least one type-source trace for the plurality of programmatic elements.

18. The system of claim 11, wherein:
the incremental type constraint resolver comprises:
a constraint hopper that is initially loaded with said at least one type constraint generated by the type constraint generator; and
a verificand having a constraint set that is initially empty; and
incremental resolution comprises transfer of constraints from the constraint hopper to the constraint set of the verificand in batches having a size of at least one.

19. The system of claim 11, wherein:
the incremental type constraint resolver comprises a type coercion matrix specifying, at least, allowable type coercions; and
incremental resolution comprises:
type constraint unification; and
upon detecting a unification anomaly, checking the type coercion matrix for an allowable type coercion to compensate for the unification anomaly.

20. The system of claim 11, wherein the programming language has at least some of the features of ECMAScript.
